(19) United States
(12) Patent Application Publication
(10) Pub. No.: US 2009/0179409 A1
(43) Pub. Date: Jul. 16, 2009

(54) Cut, sewn, and laminated inflatable vehicle occupant protection device construction

(75) Inventors: Bruce R. Hill, Bloomfield Hills, MI (US); Eric J. Eckelberg, Macomb, MI (US); Michelle M. Blackson, Dryden, MI (US)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Vehicle Safety Systems Inc.

(21) Appl. No.: 12/009,041

(22) Filed: Jan. 16, 2008

(51) Int. Cl. B60R 21/23; B32B 7/08

(52) U.S. Cl. 280/743.1; 156/93

(57) ABSTRACT

An inflatable vehicle occupant protection device (14) includes a woven panel (41) comprising first and second side panels (40 and 42) positioned overlying each other. The side panels (40 and 42) are not coated or laminated on any surface. Stitching (58) extends through and interconnects the overlying first and second panels (40 and 42). A film layer (75) is laminated onto the woven panel (41) covering an outer surface of the woven panel and the stitching (58).

### FIELD OF THE INVENTION

The present invention relates to a cut, sewn, and laminated inflatable vehicle occupant protection device.

### BACKGROUND OF THE INVENTION

It is known to inflate an inflatable vehicle occupant protection device to help protect a vehicle occupant. Examples of inflatable vehicle occupant protection devices include driver and passenger frontal air bags, side air bags, and inflatable knee bolsters. One particular type of inflatable vehicle occupant protection device is an inflatable curtain.

An inflatable curtain will inflate in response to the occurrence of an event for which inflation of the inflatable curtain is desired, such as a side impact to the vehicle, a vehicle rollover, or both. The inflatable curtain inflates away from a roof of the vehicle between a side structure of the vehicle and a vehicle occupant. A known inflatable curtain is inflated by inflation fluid directed from an inflator to the inflatable curtain via a fill tube.

Inflatable curtains may have a variety of constructions. For example, an inflatable curtain may be constructed of woven panels that are interconnected by suitable means, such as stitching, ultrasonic welding, or adhesive bonding. The gas impermeability of the inflatable curtain may be improved by coating the curtain with a material, such as silicone or polyurethane via spray coating or knife spreading. Alternatively, a film sheet material, such as polyurethane or co-polyester, may be laminated to the inflatable curtain to improve gas impermeability.

### SUMMARY OF THE INVENTION

The present invention relates to an inflatable vehicle occupant protection device that includes a woven panel (41) comprising first and second side panels (40 and 42) positioned overlying each other. The side panels (40 and 42) are not coated or laminated on any surface. Stitching (58) extends through and interconnects the overlying first and second panels (40 and 42). A film layer (75) is laminated onto the woven panel (41) covering an outer surface of the woven panel and the stitching (58).

The present invention also relates to an inflatable vehicle occupant protection device including first and second panels of woven material positioned overlying each other. The second panel is configured to leave exposed portions of the first panel extending about a periphery of the first panel. Stitching extends through and interconnects the overlying first and second panels. A first film layer overlies the first panel and covers the stitching. A second film layer overlies the second panel and covers the stitching. The second film layer also covers the exposed portions of the first panel.

The present invention also relates to an inflatable vehicle occupant protection device including first and second panels of woven material positioned overlying each other. Stitching extends through and interconnects the overlying first and second panels. First and second film layers overlie the first and second panels and cover the stitching. The first and second film layers include peripheral overlap portions that extend beyond the peripheries of the first and second panels. The peripheral overlap portions overlie each other and are laminated to each other to form a peripheral edge seal that helps block inflation fluid leakage from between the first and second panels.

The present invention also relates to an inflatable vehicle occupant protection device including first and second overlying panels of woven material. A gasket is disposed between the first and second panels. The gasket includes a narrow strip of film extending along at least a portion of a periphery of the panels. Stitching extends through and interconnects the first panel, the second panel, and the gasket. A first film layer overlies the first panel and the stitching. A second film layer overlies the second panel and the stitching.

The present invention also relates to a method for manufacturing an inflatable vehicle occupant protection device. The method includes the step of providing first and second panels of woven material that are free from any coating or lamination on any surface. The method also includes the steps of positioning the first and second panels overlying each other and stitching the panels together. The method also includes the step of laminating a first film layer onto the first panel. The first film layer overlies and covers-the first panel and the stitching. The method further includes the step of laminating a second film layer onto the second panel. The second film layer overlies and covers the second panel and the stitching.

The present invention also relates to a method for manufacturing an inflatable vehicle occupant protection device. The method includes the step of providing first and second panels of woven material positioned overlying each other. The method also includes the step of configuring the second panel to leave exposed portions of the first panel extending about a periphery of the first panel. The method also includes the step of stitching together the overlying first and second panels. The method also includes the step of laminating a first film layer onto the first panel and covering the stitching. The method further includes the step of laminating a second film layer onto the second panel, onto the exposed portions of the first panel, and covering the stitching.

The present invention also relates to a method for manufacturing an inflatable vehicle occupant protection device. The method includes the step of providing first and second panels of woven material positioned overlying each other. The method also includes the step of stitching together the overlying first and second panels. The method also includes the step of providing first and second film layers that are larger than the first and second panels. The method also includes the steps of laminating the first film layer onto the first panel and over the stitching, and laminating the second film layer onto the second panel and over the stitching. The method further includes the step of laminating overlying peripheral overlap portions of the first and second film layers that extend beyond the peripheries of the first and second panels to form a peripheral edge seal.

The present invention further relates to a method for manufacturing an inflatable vehicle occupant protection device. The method includes the steps of providing first and second panels of woven material and positioning the first and second panels overlying each other. The method also includes the step of positioning a gasket between the first and second panels along at least a portion of a periphery of the panels. The method also includes the step of stitching together the first panel, second panel, and gasket. The method further includes the steps of laminating a first film sheet onto the first panel over the stitching and laminating a second film sheet onto the second panel over the stitching.

### BRIEF DESCRIPTION OF THE DRAWINGS

The foregoing and other features of the present invention will become apparent to one skilled in the art to which the present invention relates upon consideration of the following description of the invention with reference to the accompanying drawings, in which:

FIG. 1 is a schematic view of an apparatus for helping protect an occupant of a vehicle, according to the present invention;

FIG. 2 is a sectional view of a portion of the apparatus taken generally along line 2-2 in FIG. 1;

FIG. 3 is an exploded perspective view of a portion of the apparatus of FIG. 1;

FIG. 4 is a plan view of a portion of the apparatus of FIG. 1;

FIGS. 5 and 6 are plan views illustrating the manufacture of certain components of the apparatus;

FIGS. 7A-7C are plan views illustrating the manufacture of the apparatus;

FIG. 7D is a graph illustrating the pressure of the apparatus over time;

FIGS. 8A-8C are block diagrams illustrating a method of manufacturing an apparatus for helping protect an occupant of a vehicle, according to the present invention;

FIG. 9 is an exploded perspective view of an apparatus for helping protect an occupant of a vehicle, according to a second embodiment of the present invention;

FIG. 10 is a plan view of the apparatus of FIG. 9 in an assembled condition;

FIG. 11 is a sectional view taken generally along line 11-11 in FIG. 10;

FIG. 12 is a block diagram illustrating a method of manufacturing an apparatus for helping protect an occupant of a vehicle, according to the second embodiment of the present invention; and

FIG. 13 is a block diagram illustrating a method of manufacturing an apparatus for helping protect an occupant of a vehicle, according to the present invention.

### DESCRIPTION OF EMBODIMENTS

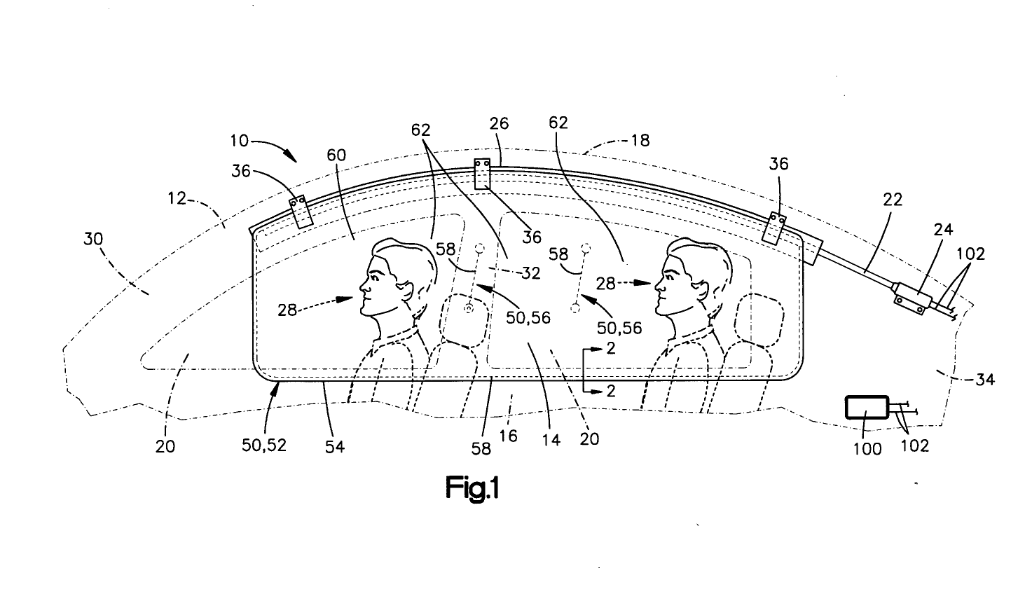

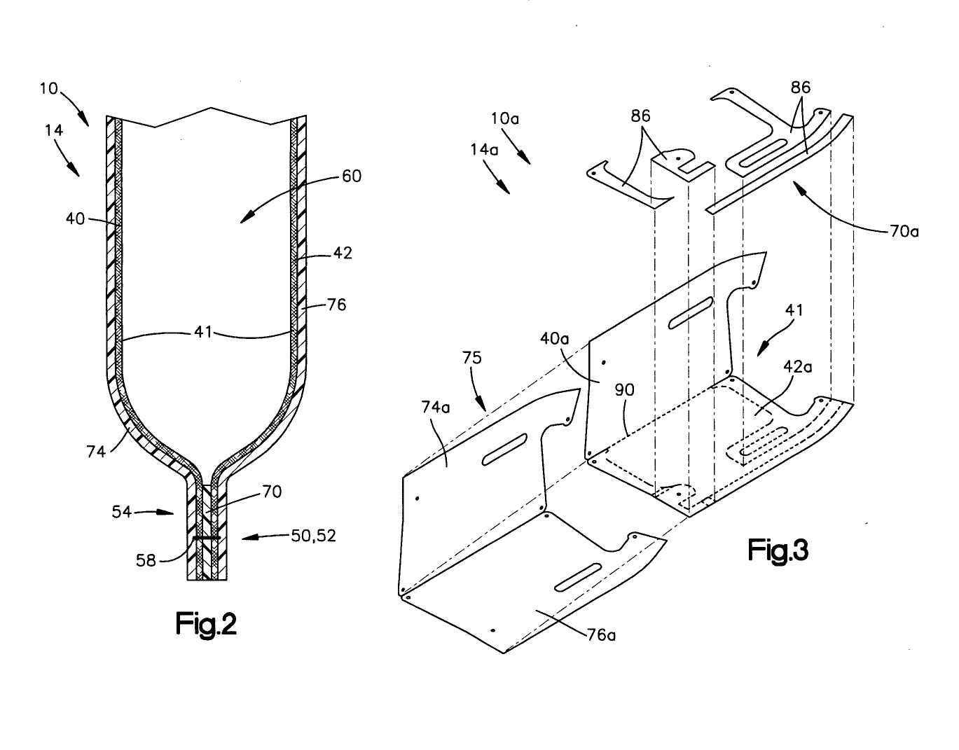

An apparatus 10 helps to protect one or more occupants 28 of a vehicle 12. As shown in FIGS. 1 and 2, the apparatus 10 includes an inflatable vehicle occupant protection device in the form of an inflatable curtain 14. The present invention may include an inflatable vehicle occupant protection device in an alternative form (not shown), such as a driver front impact air bag, a passenger front impact air bag, a side impact air bag, an inflatable seat belt, or an inflatable knee bolster.

The inflatable curtain 14 is mounted adjacent a side structure 16 of the vehicle 12 and a roof 18 of the vehicle. The side structure 16 of the vehicle 12 includes side windows 20, an A pillar 30, a B pillar 32, and a C pillar 34. An inflator 24 is connected in fluid communication with the inflatable curtain 14 through a fill tube 22. The inflatable curtain 14, fill tube 22, and inflator 24 are connected to the vehicle 12 by means 36, such as brackets.

In the illustrated embodiment, the inflatable curtain 14, when inflated, extends from the A pillar 30 to the C pillar 34. Those skilled in the art will appreciate that alternative configurations could be built without departing from the teachings of the present invention. For example, the inflatable curtain 14 could be configured to extend from the A pillar 30 to the B pillar 32 only or from the A pillar to a D pillar (not shown) of the vehicle 12.

The fill tube 22 has an end portion for receiving fluid from the inflator 24. The fill tube 22 may be connected directly to the inflator 24 or a manifold (not shown) may connect the fill tube to the inflator. The fill tube 22 has a portion, disposed in the inflatable curtain 14 that has openings (not shown) through which inflation fluid is directed into curtain. The fill tube 22 may be constructed of any suitable material, such as plastic, metal or fabric. As a further alternative, those skilled in the art will appreciate that the fill tube 22 may be omitted, in which case the inflator 24 may be connected directly to the inflatable curtain 14.

The inflator 24 contains a stored quantity of pressurized inflation fluid (not shown) in the form of a gas for inflating the inflatable curtain 14. The inflator 24 alternatively could contain a combination of pressurized inflation fluid and ignitable material for heating the inflation fluid, or could be a pyrotechnic inflator that uses the combustion of gas-generating material to generate inflation fluid. As a further alternative, the inflator 24 could be of any suitable type or construction for supplying a medium for inflating the inflatable curtain 14.

The apparatus 10 includes a housing 26 (FIG. 1) for storing the inflatable curtain 14 in a deflated condition. The fill tube 22, the deflated inflatable curtain 14, and the housing 26 have an elongated configuration and extend along the vehicle roof 18 and along the side structure 16 of the vehicle 12 above the side windows 20. The fill tube 22, inflatable curtain 14, and housing 26 are connected to the vehicle 12 by means 36, such as brackets.

Referring to FIG. 2, the inflatable curtain 14 comprises first and second woven panels 40 and 42 that are arranged in an overlying manner. The inflatable curtain 14 includes connections 50 that interconnect the woven panels 40 and 42 to help define an inflatable volume 60 of the inflatable curtain 14. Referring to FIGS. 1 and 2, the connections 50 may include perimeter connections 52 extending along a periphery 54 of the inflatable curtain 14. The connections 50 may also include interior connections 56 positioned within the periphery 54 of the inflatable curtain.

The connections 50 may help define inflatable chambers 62 within the inflatable volume 60. Certain connections 50, such as the interior connections 56, may also form non-inflatable portions of the inflatable curtain 14 positioned within the inflatable volume 60. In the illustrated embodiment, the connections 50 comprise stitching 58 that extends through and interconnects the first and second panels 40 and 42.

Referring to FIG. 2, the inflatable curtain 14 includes a gasket 70 positioned between the first and second woven panels 40 and 42. The gasket 70 is in the form of a strip, for example, about 50mm wide, that extends along the periphery 54 of the inflatable curtain 14 where the connections 50 interconnect the overlying woven panels 40 and 42. The gasket 70 prevents gas from escaping between the woven fabric layers 40 and 42.

The inflatable curtain 14 also includes a first film panel 74 disposed on the first woven panel 40 and a second film panel 76 disposed on the second woven panel 42. The first film panel 74 covers the outer surface of the first woven panel 40, including the stitching 50. The second film panel 74 covers the outer surface of the second woven panel 42, including the stitching 50. The first and second film panels 74 and 76 are laminated to the first and second woven panels 40 and 42, respectively. The gasket 70 is positioned between and laminated to the first and second woven panels 40 and 42.

The vehicle 12 includes a sensor (shown schematically at 100 in FIG. 1) for sensing the occurrence of an event for which inflation of the inflatable curtain 14 is desired, such as a side impact, a vehicle rollover, or both. Upon sensing the event, the sensor 100 provides an electrical signal over lead wires 102 to the inflator 24. The electrical signal causes the inflator 24 to be actuated in a known manner. The inflator 24 discharges fluid under pressure through fill tube 22, which directs the fluid into the inflatable curtain 14.

The inflatable curtain 14 inflates under the pressure of the inflation fluid from the inflator 24. The housing 26 (FIG. 1) opens, and the inflatable curtain 14 inflates away from the roof 18 in a downward direction as shown in the drawings and in a downward direction with respect to the direction of forward vehicle travel into the position illustrated in FIGS. 1 and 2. The inflatable curtain 14, when inflated, is positioned between the side structure 16 of the vehicle 12 and any occupants 28 of the vehicle.

The inflatable curtain 14, when inflated, helps to protect a vehicle occupant in the event of a vehicle rollover or a side impact to the vehicle 12. The inflatable curtain 14, when inflated, helps to absorb the energy of impacts with the curtain and helps to distribute the impact energy over a large area of the curtain. The gasket 70 and film panels 74 and 76 help maintain the inflation fluid pressure in the inflatable curtain 14 at a desired level and help block inflation fluid leakage through the panels and through the seams or stitching.

According to the present invention, the inflatable curtain 14 has a cut, sewn, and laminated construction that helps maintain inflation fluid pressure in the curtain and helps prevent inflation fluid leakage from the curtain. This construction includes overlying panels that are 1) cut from an uncoated and unlaminated stock woven sheet of material, 2) sewn together, and 3) laminated with a film to form an effective seal for the inflatable curtain 14. Also, the cut, sewn, and laminated construction of the inflatable curtain 14 is efficient in terms of material usage, production time, and manufacturing costs.

In describing the construction and performance of the inflatable curtain of the present invention reference is made to FIGS. 3-7C. FIGS. 3-7C illustrate a test configuration of the apparatus constructed in accordance with the present invention. The configuration of the apparatus illustrated in FIGS. 3-7C is similar to the configuration of the apparatus illustrated in FIGS. 1 and 2. Accordingly, numerals similar to those of FIGS. 1 and 2 will be utilized in FIGS. 3-7C to identify similar components, the suffix letter “a” being associated with the numerals of FIGS. 3-7C to avoid confusion.

The apparatus 10a of FIGS. 3-7C includes an inflatable curtain 14a of a size commensurate with a typical “A-B” curtain, i.e., a curtain that extends between the A pillar 30 (see FIG. 1) and the B pillar 32 of the vehicle 12.

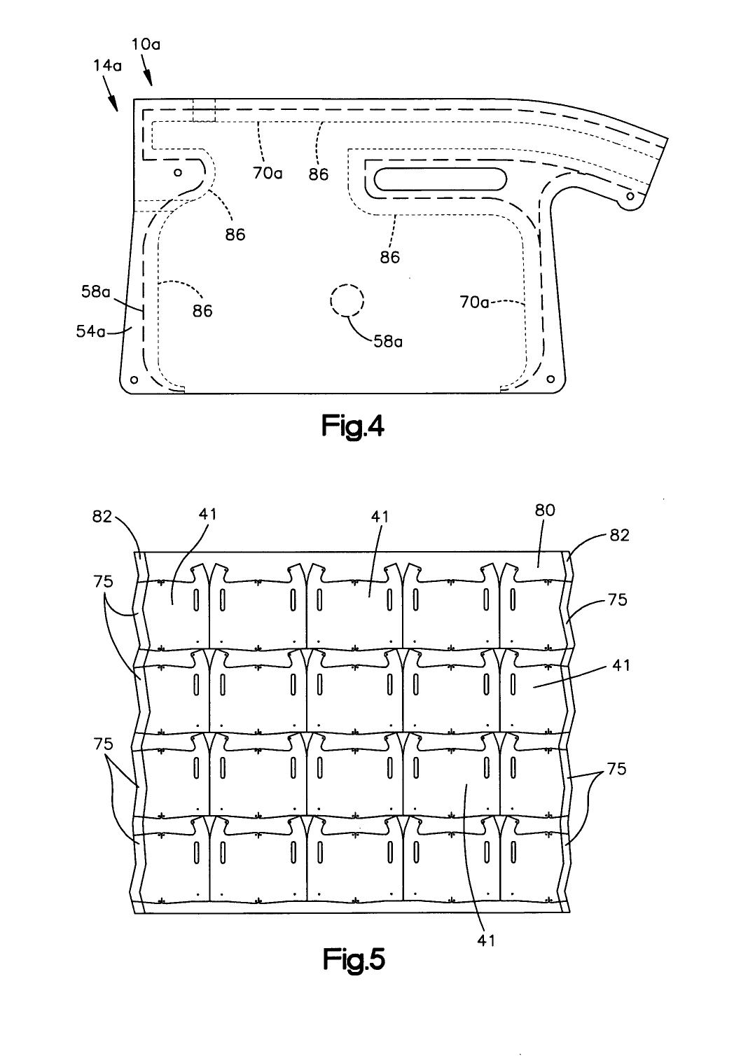

Referring to FIGS. 3 and 4, with the exception of shape and size, the inflatable curtain 14a has a construction similar to that shown in FIGS. 1 and 2. The inflatable curtain 14a thus includes a single “butterfly” woven panel 41 that is folded at 90 to define woven side panels 40a and 42a, a single butterfly film panel 75 that is similarly folded creating film side panels 74a and 76a, and a gasket 70a. Referring to FIG. 5, the butterfly woven panel 41 is cut from a sheet 80 of woven material in a manner that produces little waste. Since the film panel 75 is identical or substantially identical to the woven panel 41, the film panel similarly may be cut from a sheet 82 of film material in a similar or identical pattern, thus producing little waste.

Also, according to the present invention, the film panel 75 and the woven panel 41 may be cut from their respective sheets simultaneously. With the woven sheet 80 and film sheet 82 overlying each other as shown in FIG. 5, means (not shown) such as laser cutting can be employed to cut the woven panel 41 and film panel 75 simultaneously. This eliminates the need to perform separate cutting operations. Thereafter, the film panel 75 can be moved away from the woven panel 41.

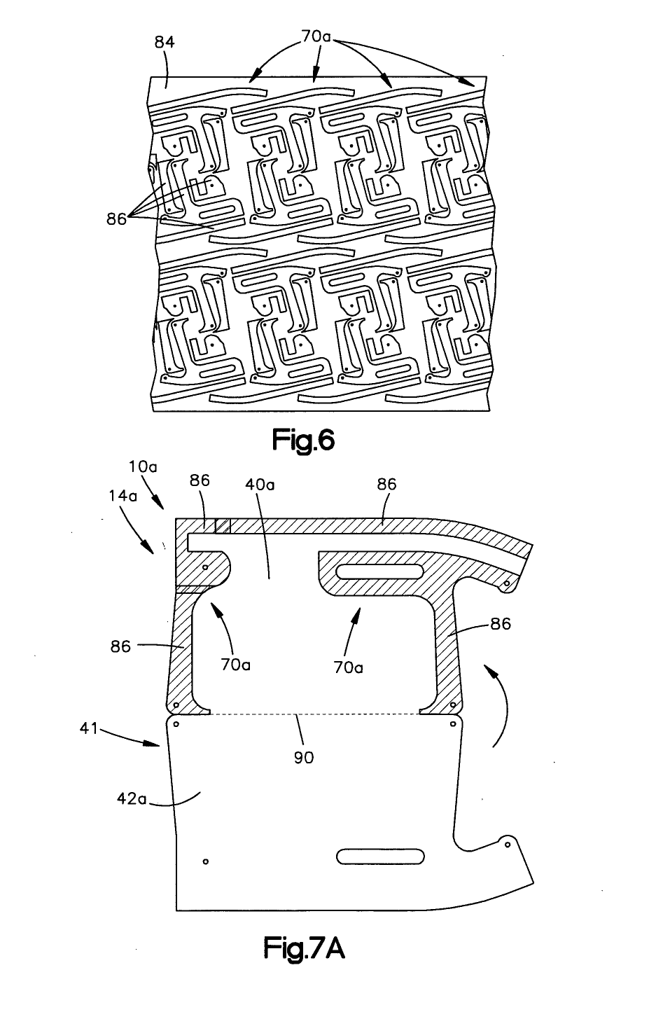

Referring to FIG. 6, according to the present invention, the gasket 70a is cut from a sheet 84 of gasket material, such as a film material, in a pattern that helps reduce waste. The gasket 70a is cut out from the film sheet 84 using means (not shown) such as a die or laser cutting. Referring to FIGS. 3 and 6, the sheet 84 is cut in several distinct gasket pieces 86 that, in combination, form the gasket 70a when installed between the woven side panels 40a and 42a. As shown in FIG. 6, this allows the different gasket pieces 86 to be arranged and nested together so as to make more efficient use of the film sheet 84 by helping to reduce waste.

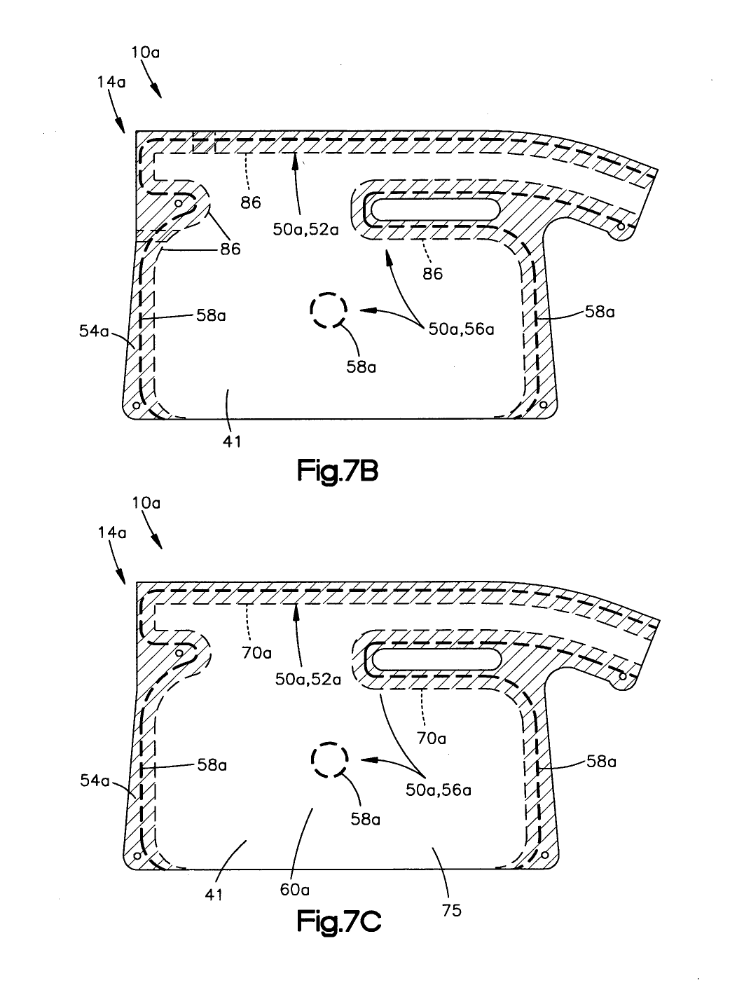

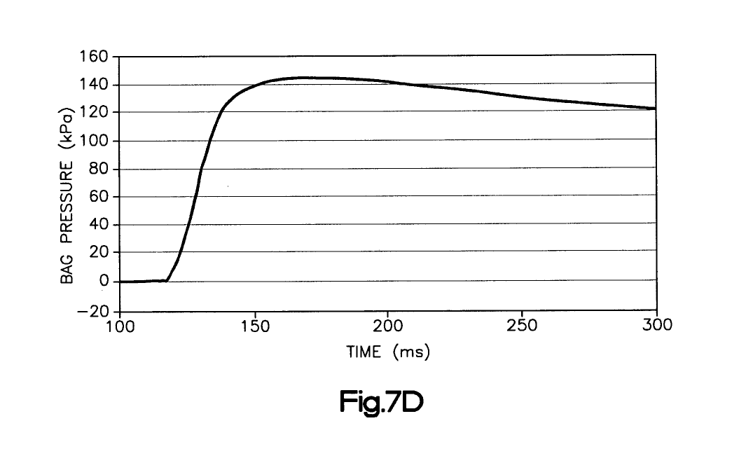

Referring to FIGS. 3 and 7A, to assemble the inflatable curtain 14a, the gasket pieces 86 are arranged on one of the woven side panels 40a and 42a. In the embodiment illustrated in FIG. 7A, the gasket pieces 86 are arranged on the first woven side panel 40a. The woven panel 41 is then folded along a fold line 90 so that the gasket pieces 86 are sandwiched between the side panels 40 and 42, as shown in FIG. 7B. The woven side panels 40a and 42a and the gasket pieces 86 are interconnected via connections 50a, i.e., stitching 58a, that extend through the side panels and gasket. As shown in FIG. 7B, the perimeter connections 52a extend through the gasket 70a and the side panels 40a and 42a along the periphery 54a of the inflatable curtain 14a. The interior connections 56a extend through the gasket 70a and the side panels 40a and 42a at locations spaced from, or interior to, the periphery 54a of the inflatable curtain 14a within the perimeter of the inflatable volume 60a.

Once the gasket 70a and side panels 40a and 42a are interconnected via the connections 50a, the film panel 75 is placed overlying the first and second side panels 40a and 42a, respectively. The film panel 75 and the gasket 70a are then laminated to the woven side panels 40a and 42a through the application of heat and pressure via known means, such as heated rollers or platens. Advantageously, no curing is required when laminating the materials together.

The film materials and gasket 70a may be any plastic or elastomeric film material suitable for manufacturing the inflatable curtain 14a in accordance with the methods described herein, and capable of displaying desired properties, such as leak prevention, adhesion, and anti-blocking performance.

The film material typically consists of an adhesive layer and a surface layer. The surface layer has a melt temperature substantially above the adhesive layer. This is typically referred to as a Duplex or Co-ex film. The gasket and adhesive layer should have similar thermal properties. The film material can also be made up of two separate films, the first an adhesive and the second a surface film. In either case, the adhesive film is positioned between the woven panel and the surface film. The gasket film is positioned in-between the woven fabric sides.

The materials used to construct the woven panels 40a and 42a are selected to provide desired performance characteristics, such as strength, abrasion resistance, puncture resistance, and gas impermeability. For example, the panel 41 may be constructed of a fabric woven in a 1×1 plain weave pattern using a conventional weaving process, such as rapier, air jet, or water jet weaving. In one example, the yarn used to construct the panel 41 may be a 470 dtex (470 grams per 10,000 meters) polyamide 66 (PA66) nylon yarn. The construction may have a relatively low weave density, such as 18 picks/cm and 18 ends/cm. In another example, the yarn used to construct the woven panel 41 may be a 350 dtex PA66 nylon yarn with a relatively low weave density, such as 21 picks/cm and 21 ends/cm.

The thread used to interconnect the side panels 40a and 42a may also be a PA66 nylon thread, such as a T135 (135 grams per 1,000 meters) PA66 nylon thread or a T90 PA66 nylon thread. In one example configuration, a T135 PA66 thread may be used in a double needle lock stitch pattern in which the needle spacing is approximately 3 mm.

Constructed in accordance with the above description, the inflatable curtain 14a is configured to exhibit exceptional performance in terms of blocking or otherwise preventing leakage. The film panel 75 helps block inflation fluid leakage through the woven panel 41 and also through the stitching 58a and the areas of the panels through which the stitching extends. The gasket 70a also helps block inflation fluid leakage through the stitching 58a and the areas of the panels adjacent the stitching and through which the stitching extends. The gasket 70a provides the additional advantage of helping to block inflation fluid from between the overlying side panels 40a and 42a.

### EXAMPLES

To evaluate and illustrate the effectiveness of the curtain construction described above, a test curtain was prepared. The test curtain had the same basic cut, sewn, and laminated configuration shown in FIGS. 3-7C. In this construction, the woven panels were cut from conventional uncoated, unlaminated 350 dtex PA66 nylon fabric woven in a 1×1 plain weave with a weave density of 23 picks/cm and 23 ends/cm. A gasket comprising two layers of Collano® 22.000 adhesive film with a weight of about 30 g/m² was positioned between the overlying woven panels. The panels and the gasket material were stitched together using T90 PA66 nylon sewing thread at 50 stitches per decimeter. One set of curtains were then laminated with a Collano® 55.504C duplex film with a weight of 57 g/m². A second set of curtains were laminated with a Collano® co-ex film V763 with a weight of 40 g/m². Collano® adhesive, duplex and co-ex films are available commercially from Collano, Inc. of Greenville, S.C., USA.

The curtain was tested using a deployment simulation device. Helium was used to pressurize the bag to approximately 140 kPa. The time required to reach this pressure from 0 kPa is typically about 50 milliseconds (see FIG. 7D). After deployment, the curtain was inflated with shop air to 70 kPa and the pressure decay after 6 seconds was measured. The results of these tests are illustrated below in Table 1:

TABLE 1

Pressure Decay
After 6 Seconds

| Film | Trial 1 | Trial 2 |
|---|---|---|
| Duplex | 48 | 48 |
| Co-ex | 50 | 42 |

The pressure maintaining criteria for an inflatable curtain can vary, depending on a variety of factors, such as the architecture of the vehicle and the particular government or automaker standards against which the inflatable curtain is judged. For example, generally speaking, for a full size rollover inflatable curtain, it may be desirable to maintain 50% of peak pressure at 6 seconds after deployment.

In general, for any particular inflatable curtain construction, the volumetric flow rate of inflation fluid from the inflatable curtain is typically highest in areas of the curtain that undergo high stresses both during deployment and post-deployment. Examples of these high stress areas may be those areas adjacent or near the location where the inflator extends into and is secured to the inflatable curtain.

The volumetric flow rate of inflation fluid through these high stress areas of the inflatable curtain does not depend on the size or volume of the curtain itself. The size or volume of the inflatable curtain does, however, impact the rate of curtain depressurization resulting from the volumetric flow rate of inflation fluid through those high-stress areas of the curtain. Therefore, those skilled in the art will appreciate that, with the volumetric flow rate through the high stress areas being equal, inflation fluid pressure in the curtain will decay more rapidly in a smaller, low volume curtain than in a larger, high volume curtain.

The test configuration used to perform the tests illustrated in Table 1, i.e., the configuration illustrated in FIGS. 7A-7C, is much smaller than a conventional A-C pillar inflatable curtain—less than 10% by volume. Therefore, those skilled in the art will appreciate that inflation fluid pressure in the test curtain will decay much more rapidly than in a full size A-C pillar curtain configuration. The inflatable curtain construction illustrated in FIGS. 1-7c thus displays exemplary performance in terms of gas holding and leakage preventing properties.

From the above, those skilled in the art will appreciate that the embodiment of the present invention illustrated in FIGS. 3-7 discloses an inflatable curtain 14a having a design that exhibits desirable gas holding properties. In terms of manufacturing, the inflatable curtain design is both efficient and cost effective. The inflatable curtain 14a utilizes overlying side panels 40a and 42a of woven fabric that are uncoated and unlaminated prior to curtain assembly. Once the uncoated, unlaminated overlying side panels 40a and 42a are stitched together, film panel 75 is laminated onto the outer surfaces of the panels so as to cover the panels and the stitching 58a. The film panel 75 provides an effective seal that helps block or resist gas leakage through the panels 40a and 42a and through the stitching 58a. The gasket 70a, laminated between the side panels 40a and 42a, helps bolster or improve this seal.

Advantageously, the film panel 75 can be applied simultaneously, does not require curing, and requires little time to cool, which helps reduce manufacturing time. The fact that the woven panel 41 is free from any coatings further helps to reduce manufacturing time, due to the fact that coatings typically require a, significant amount of time for curing.

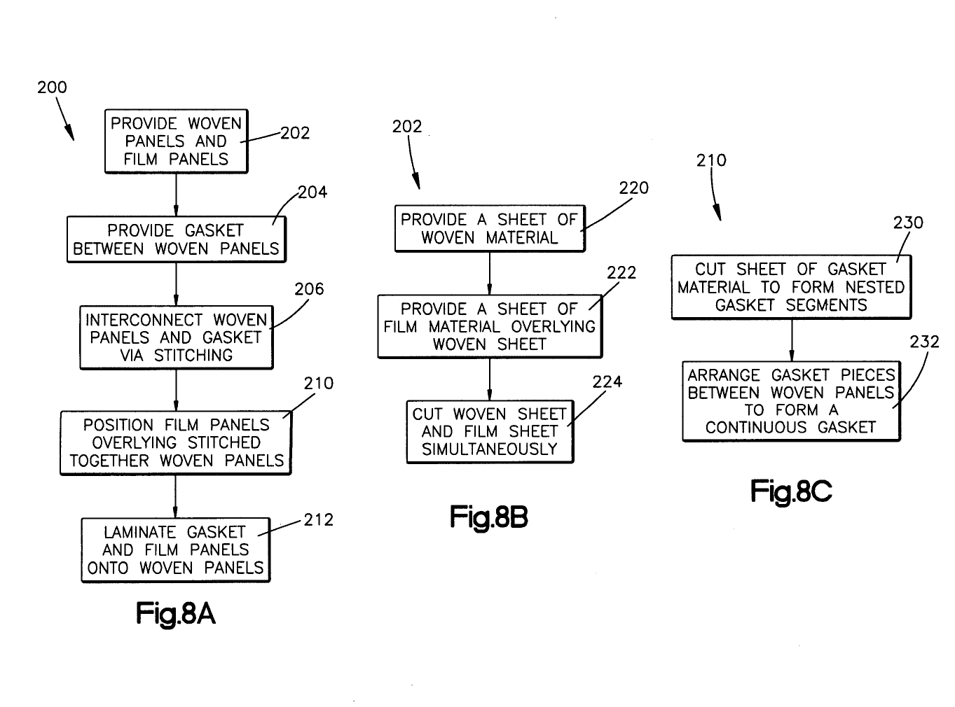

Also, from the above, those skilled in the art will appreciate that the embodiment of the present invention illustrated in FIGS. 3-7 relates not only to the construction of the inflatable curtain 14a per se, but also to the method by which the inflatable curtain is manufactured. More particularly, referring to FIG. 8A, a method 200 for manufacturing an inflatable vehicle occupant protection device (e.g., an inflatable curtain) includes the step 202 of providing first and second woven panels and first and second film panels. At step 204, a gasket is provided and positioned between the overlying woven panels. At step 206, the woven panels and the gasket are interconnected by stitching that extends through the panels and the gasket. The method 200 also includes the step 210 of positioning first and second film panels overlying the outer surfaces of the stitched together first and second woven panels, respectively. The method 200 further includes the step of laminating the gasket and the film panels to the woven panels.

The method 200 illustrated in FIG. 8A and described above relates to the manufacture of the inflatable curtain so as to incorporate the gas holding and leakage preventing characteristics described and illustrated above. According to the present invention, the method 200 for manufacturing the inflatable curtain 14 also includes steps that improve the efficiency and cost effectiveness associated with the manufacture of the inflatable curtain 14.

For example, referring to FIG. 8B, the step 202 of providing first and second woven panels and first and second film panels comprises the step 220 of providing a sheet of woven fabric material and the step 222 of providing a sheet of film overlying the fabric sheet. The step 202 further comprises the step 224 of cutting the overlying woven sheet and film sheet simultaneously to form the first and second woven panels and the first and second film panels.

As another example, referring to FIG. 8C, the step 210 of providing and positioning the gasket includes the step 230 of cutting a sheet of gasket material to form gasket segments in a nested manner that produces a reduced or minimal amount of material waste. The step 210 also includes the step 232 of arranging the segments between the woven panels to form a continuous gasket.

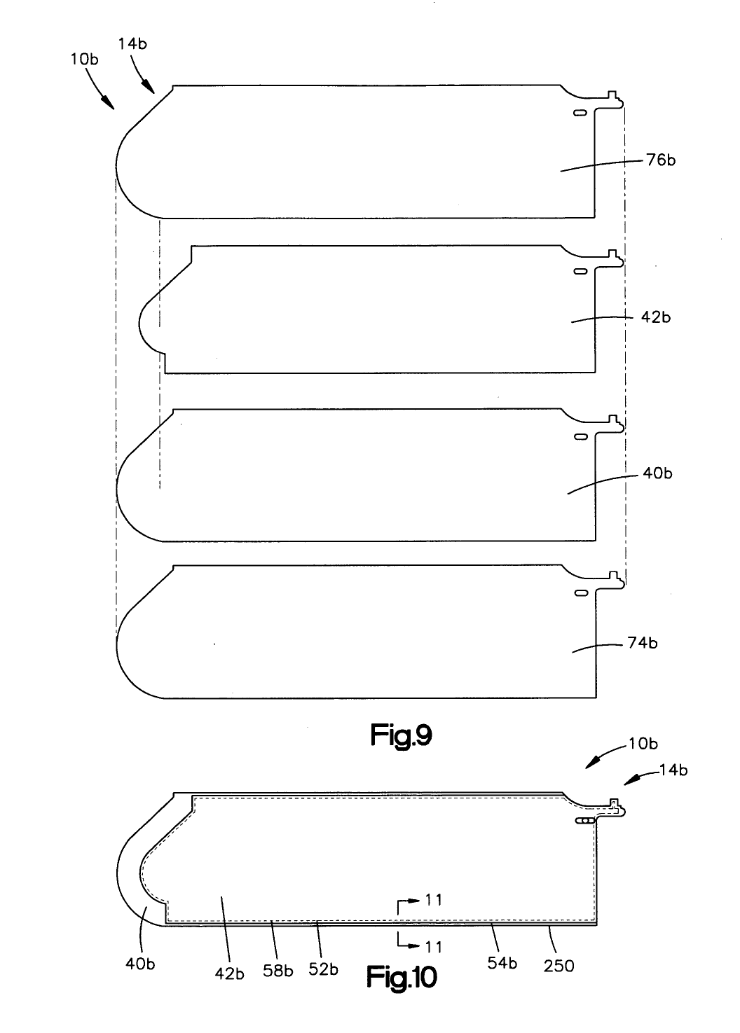

A second embodiment of the present invention is illustrated in FIGS. 9-11. The second embodiment of the invention is similar to the first embodiment of the invention illustrated in FIGS. 1-8C. Accordingly, numerals similar to those of FIGS. 1-8C will be utilized in FIGS. 9-11 to identify similar components, the suffix letter “b” being associated with the numerals of FIGS. 9-11 to avoid confusion.

The inflatable curtain 14b of the second embodiment has a cut, sewn, and laminated construction that helps maintain inflation fluid pressure in the curtain and helps prevent inflation fluid leakage from the curtain. This construction includes overlying panels that are 1) cut from an uncoated and unlaminated stock woven sheet of material, 2) sewn together, and 3) laminated with a film to form an effective seal for the inflatable curtain 14b. Also, the cut, sewn, and laminated construction of the inflatable curtain 14b is efficient in terms of material usage, production time, and manufacturing costs.

Referring to FIGS. 9-11, the inflatable curtain 14b includes overlying panels 40b and 42b, and film panels 74b and 76b. The inflatable curtain 14b does not include a gasket. The first and second panels 40b and 42b are cut from a sheet of woven material in a manner that produces little waste. As best illustrated in FIGS. 9 and 10, the first and second panels 40b and 42b are not identical. Rather, the first panel 40b is sized slightly larger than the second panel 42b and has a configuration that differs slightly from that of the second panel. As shown in FIG. 10, this difference in size and configuration produces a peripheral overlap portion 250 of the first panel 40b that extends along the periphery 54b of the inflatable curtain 14b.

The first and second film panels 74b and 76b of the second embodiment have a configuration identical or substantially identical to the first panel 40b. To assemble the inflatable curtain 14b, the woven panels 40b and 42b are positioned overlying each other and interconnected via connections 50b, i.e., stitching 58b, that extend through the panels. As shown in FIG. 11, the stitching 58b of the perimeter connection 52b extends through the panels 40b and 42b along the periphery 54b of the inflatable curtain 14b.

Once the panels 40b and 42b are interconnected via the connections 50b, the first and second films 74b and 76b are placed overlying the first and second panels 40b and 42b, respectively. The first and second films 74b and 76b are then laminated to the woven panels 40b and 42b through the application of heat and pressure via known means, such as heated rollers or platens. Advantageously, no curing is required when laminating the films 74b and 76b and the gasket 70b.

As shown in FIG. 11, according to the second embodiment of the present invention, the second film 76b, being configured to match the first panel 40b and being positioned overlying the second panel 42b, is laminated to the second panel 42b and the peripheral overlap portion of the first panel 40b. The second film 76b covers the stitching 58b and extends beyond the terminal edge of the second panel 42b. The second film 76b thus forms a peripheral edge seal 252 that helps block inflation fluid from leaking between the overlying panels 40b and 42b.

The film materials used to construct the first and second films 74b and 76b may be any plastic or elastomeric film material suitable for manufacturing the inflatable curtain 14b in accordance with the methods described herein, and capable of displaying desired properties, such as leak prevention, adhesion, and anti-blocking performance.

For example, the first and second films 74b and 76b may comprise an adhesive film and a surface film. The adhesive film and surface film of the first and second films 74b and 76b may comprise separate film layers that are positioned overlying their corresponding panels 40b and 42b of the inflatable curtain 14b with the adhesive film layers being positioned adjacent the panels. Alternatively, the first and second films 74b and 76b may comprise a duplex film comprising a single sheet with an adhesive film layer and a surface film layer. In this instance, the duplex first and second surface films 74b and 76b are positioned overlying their corresponding panels 40b and 42b of the inflatable curtain 14b with the adhesive film layers positioned adjacent the panels.

The materials used to construct the woven panels 40b and 42b are selected to provide desired performance characteristics, such as strength, abrasion resistance, puncture resistance, and gas impermeability. For example, the first and second panels 40b and 42b may be constructed of a fabric woven in a 1×1 plain weave pattern using a conventional weaving process, such as rapier, air jet, or water jet weaving. In one example, the yarn used to construct the panels 40b and 42b may be a 470 dtex (470 grams per 10,000 meters) polyamide 66 (PA66) nylon yarn. The construction may have a relatively low weave density, such as 18 picks/cm and 18 ends/cm. In another example, the yarn used to construct the panels 40b and 42b may be a 350 dtex PA66 nylon yarn with a relatively low weave density, such as 23 picks/cm and 23 ends/cm.

The thread used to interconnect the panels 40b and 42b may also be a PA66 nylon thread, such as a T135 (135 grams per 1,000 meters) PA66 nylon thread or a T90 PA66 nylon thread. In one example configuration, a T135 PA66 thread may be used in a double needle lock stitch pattern in which the needle spacing is approximately 3 mm.

Also, as with the embodiment of FIGS. 3-7C, the inflatable curtain 14b of FIGS. 9-11 may have a “butterfly” construction in which the first and second panels 40b and 42b are constructed of a single woven panel and the first and second films 74b and 76b are constructed as a single film sheet. The single woven panel would be folded along a fold line to position the first and second panels 40b and 42b adjacent to and overlying each other. The first and second panels 40b and 42b would then be stitched together. Then, the single film sheet would be wrapped or folded around the stitched together panels 40b and 42b so that the first film 74b overlies the first panel 40b and the second film 76b overlies the second panel 42b. The films 74b and 76b are then laminated to the panels 40b and 42b.

In this instance, the portion of the single woven panel forming the second panel 42b would be configured smaller than the portion of the single woven panel forming the first panel 40b. As a result, the peripheral overlap portion 250 is formed when the panels are folded to overlie each other. The portions of the single film sheet forming both the first and second films 74b and 76b would be configured the same as the first panel 40b. The second panel 42b would be configured smaller than the portion of the single woven panel forming the first panel 40b.

### EXAMPLES

To evaluate and illustrate the effectiveness of the curtain construction of FIGS. 9-11, three sets of three test curtains were prepared. All three sets had the same basic configuration—that shown in FIGS. 9-11, the difference being in the materials used to construct the curtains and the manner in which the curtains were sealed against leakage. The three sets of curtains were constructed as follows:

### 1. First Curtain Set

The first curtain set included inflatable curtains in which the woven panels were cut from conventional 585 dtex PA66 fabric woven in a 1×1 plain weave with a weave density of 17 picks/cm and 17 ends/cm. The fabric was coated on one side with 25 grams/square meter of silicone. The silicone coated sides of the panels were positioned on the inside of the curtains. The panels were stitched together using T90 PA66 sewing thread with a double needle lock stitch pattern in a stitch count of 50 stitches per 100 mm. There were no films laminated to the curtains.

### 2. Second Curtain Set

The second curtain set included inflatable curtains in which the woven panels were cut from conventional 585 dtex PA66 fabric woven in a 1×1 plain weave with a weave density of 17 picks/cm and 17 ends/cm. The fabric was uncoated. The woven panels had the same configuration, i.e., no peripheral overlap portion was formed. The panels were stitched together using T90 PA66 sewing thread with a double needle lock stitch pattern in a stitch count of 50 stitches per 100 mm. The inflatable curtain was then laminated on both sides with a duplex foil in which the adhesive layer was a polyurethane material and the surface layer was a copolyester.

### 3. Third Curtain Set

The third curtain set included cut, sewn, and laminated inflatable curtains in accordance with the present invention, as shown in FIGS. 9-11. The curtains thus included peripheral overlap portions. The inflatable curtains of the third curtain set were constructed of woven panels cut from conventional 585 dtex PA66 fabric woven in a 1×1 plain weave with a weave density of 17 picks/cm and 17 ends/cm. The fabric was uncoated. The woven panels were then stitched together along their peripheries and laminated on both sides with duplex foil sheets in which the adhesive layer was a polyurethane material and the surface layer was a copolyester. The duplex foil sheets covered the first and second panels in their entirety and thus formed the peripheral edge seal.

The curtains of all three sets were inflated with shop air to 35 kPa and the leak rate for each curtain was measured. The results of these measurements are illustrated below in Table 1:

TABLE 1

Leakage (Liters/Minute @35 kPa)

| Curtain Set | Bag 1 | Bag 2 | Bag 3 | Average |
|---|---|---|---|---|
| First Curtain Set | 81 | 78 | 95 | 85 |
| Second Curtain Set | 130 | 143 | ** | 137 |
| Third Curtain Set | 43 | 12 | 15 | 23 |

** Defect in Curtain Material Produced Unreliable Result

As shown in Table 1, the inflatable curtains of the third curtain set, which were cut, sewn, and laminated in accordance with the present invention to include the peripheral edge seal, displayed significantly improved performance in terms of gas holding and leakage preventing properties.

From the above, those skilled in the art will appreciate that the embodiment of the present invention illustrated in FIGS. 9-11 discloses an inflatable curtain 14b having a design that exhibits desirable gas holding properties. In terms of manufacturing, the inflatable curtain design is both efficient and cost effective. The inflatable curtain 14b utilizes overlying panels 40b and 42b of woven fabric that are uncoated and unlaminated prior to curtain assembly. Once the uncoated, unlaminated overlying panels 40b and 42b are stitched together, film layers 74b and 76b are laminated onto the outer surfaces of the panels so as to cover the panels and the stitching 58b. The film layers 74b and 76b provide an effective seal that helps block or resist gas leakage through the panels 40b and 42b and through the stitching 58b. The peripheral overlap portion 250, being covered by the laminated second film layer 76b, helps bolster or improve this seal.

Advantageously, the first and second film layers 74b and 76b can be applied simultaneously, do not require curing, and require little time to cool, which helps reduce manufacturing time. The fact that the panels 40b and 42b are also free from any coatings further helps to reduce manufacturing time, due to the fact that coatings typically require a significant of time for curing.

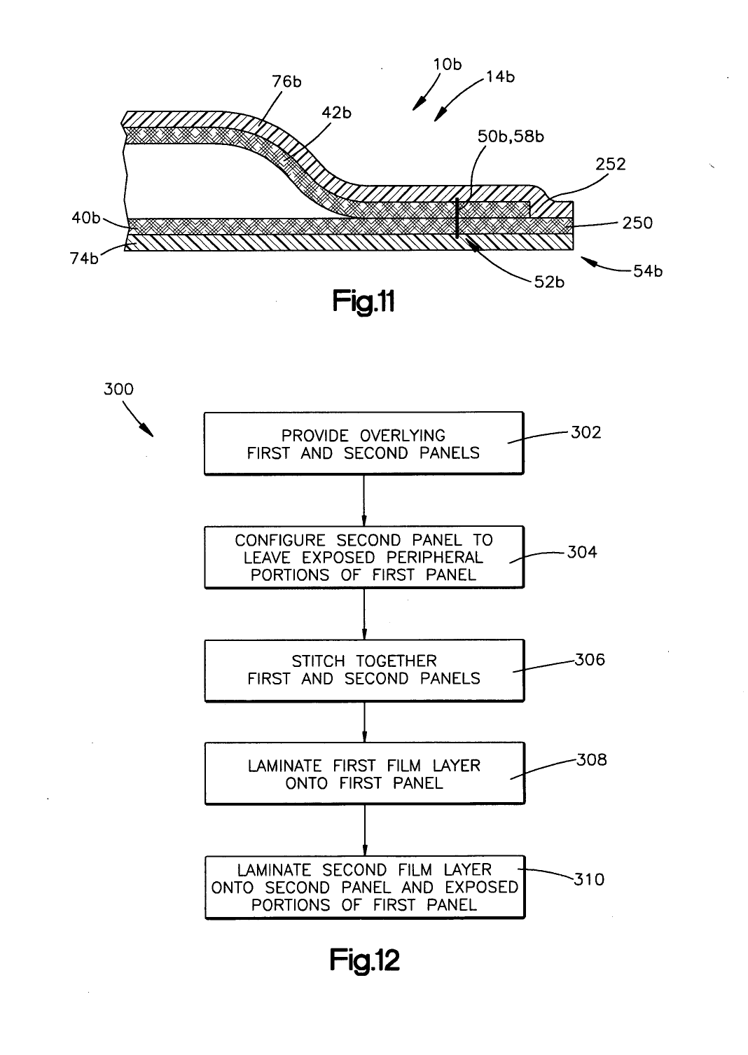

From the above, those skilled in the art will appreciate that the embodiment of the present invention illustrated in FIGS. 9-11 relates not only to the construction of the inflatable curtain 14b per se, but also to the method by which the inflatable curtain is manufactured. More particularly, referring to FIG. 12, a method 300 for manufacturing an inflatable vehicle occupant protection device (e.g., an inflatable curtain) includes the step 302 of providing first and second panels of woven material positioned overlying each other. The method 300 also includes the step 304 of configuring the second panel to leave exposed portions of the first panel extending about a periphery of the first panel. The method 300 also includes the step 306 of stitching together the overlying first and second panels. The method 300 also includes the step 308 of laminating a first film layer onto a surface of the first panel opposite the second panel. The first film layer also covers the stitching. The method 300 further includes the step 310 of laminating a second film layer onto a surface of the second panel opposite the first panel and onto the exposed portions of the first panel. The second film layer also covers the stitching.

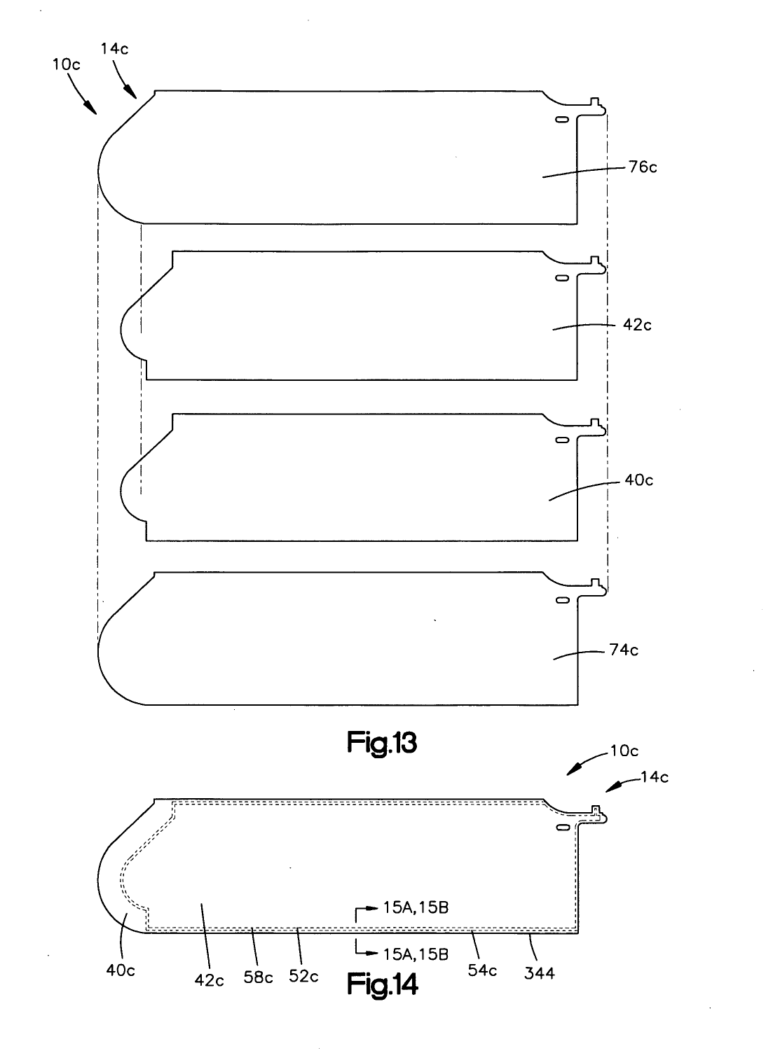

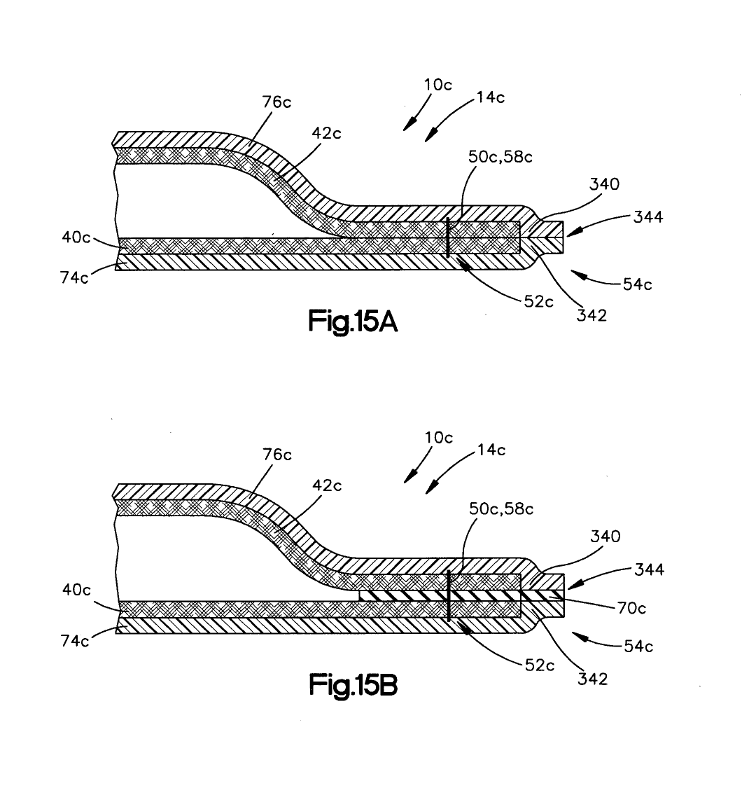

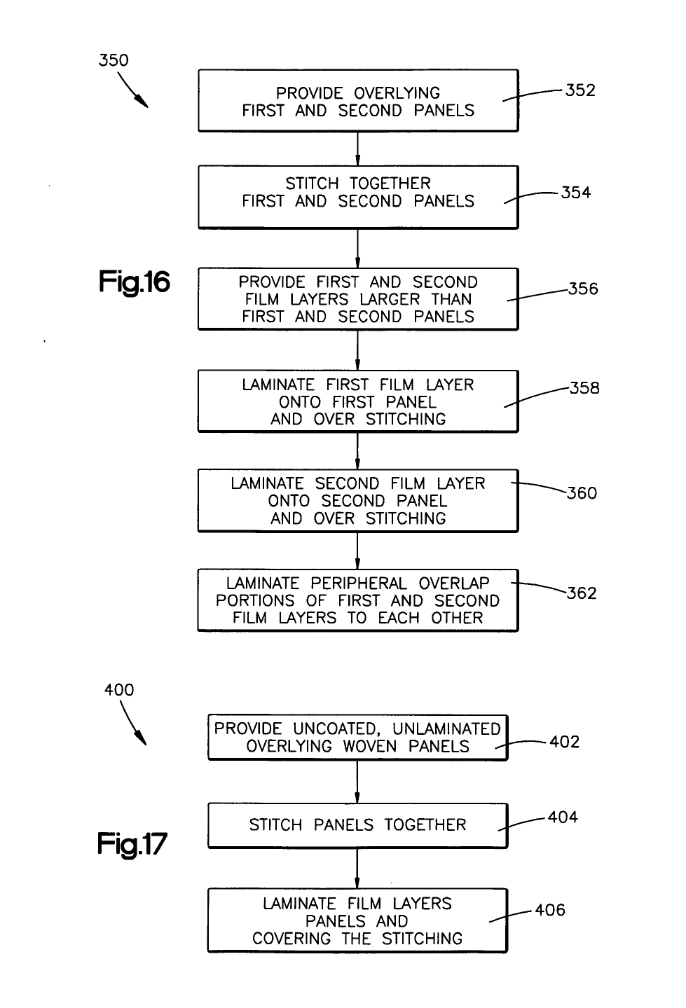

A third embodiment of the present invention is illustrated in FIGS. 13-15B. The third embodiment of the invention is similar to the first and second embodiments of the invention illustrated in FIGS. 1-11. Accordingly, numerals similar to those of FIGS. 1-11 will be utilized in FIGS. 13-15B to identify similar components, the suffix letter “c” being associated with the numerals of FIGS. 13-15B to avoid confusion.

The inflatable curtain 14c of the second embodiment has a cut, sewn, and laminated construction that helps maintain inflation fluid pressure in the curtain and helps prevent inflation fluid leakage from the curtain. This construction includes overlying panels that are 1) cut from an uncoated and unlaminated stock woven sheet of material, 2) sewn together, and 3) laminated with a film to form an effective seal for the inflatable curtain 14c. Also, the cut, sewn, and laminated construction of the inflatable curtain 14c is efficient in terms of material usage, production time, and manufacturing costs.

Referring to FIGS. 13-15B, the inflatable curtain 14c includes overlying panels 40c and 42c, and film panels 74c and 76c. The inflatable curtain 14c of FIG. 15A does not include a gasket, whereas the inflatable curtain of FIG. 15C includes a gasket 70c. The first and second panels 40c and 42c are cut from a sheet of woven material in a manner that produces little waste.

As illustrated in FIGS. 13 and 14, the first and second panels 40c and 42c are identical in configuration and size. The first and second film panels 74c and 76c of the second embodiment are also identical in configuration and size. According to the present invention, the first and second film panels 74c and 76c are configured and sized larger than the first and second panels 40c and 42c. As a result, the first and second film panels 74c and 76c comprise peripheral overlap portions 340 and 342, respectively when positioned overlying the panels 40c and 42c.

To assemble the inflatable curtain 14c, the woven panels 40c and 42c are positioned overlying each other and interconnected via connections 50b, i.e., stitching 58b, that extend through the panels. As shown in FIGS. 15A and 15B, the stitching 58c of the perimeter connection 52c extends through the panels 40c and 42c along the periphery 54c of the inflatable curtain 14c. In the embodiment of FIG. 15B, the stitching 58c of the perimeter connection 52c also extends through the gasket 70c.

Once the panels 40c and 42c are interconnected via the connections 50c, the first and second films 74c and 76c are placed overlying the first and second panels 40c and 42b, respectively. The first and second films 74c and 76c are then laminated to the woven panels 40c and 42c through the application of heat and pressure via known means, such as heated rollers or platens. Advantageously, no curing is required when laminating the films 74c and 76c and the gasket 70c.

As shown in FIGS. 15A and 15B, according to the third embodiment of the present invention, the peripheral overlap portions 340 and 342 are laminated to each other, thus forming a peripheral edge seal 344 that extends about the peripheries of the first and second panels 40c and 42c. The first and second films 74c and 76c thus help block inflation fluid from leaking between the overlying panels 40c and 42c.

The film materials used to construct the first and second films 74c and 76c may be any plastic or elastomeric film material suitable for manufacturing the inflatable curtain 14c in accordance with the methods described herein, and capable of displaying desired properties, such as leak prevention, adhesion, and anti-blocking performance.

For example, the first and second films 74c and 76c may comprise an adhesive film and a surface film. The adhesive film and surface film of the first and second films 74c and 76c may comprise separate film layers that are positioned overlying their corresponding panels 40c and 42c of the inflatable curtain 14c with the adhesive film layers being positioned adjacent the panels. Alternatively, the first and second films 74c and 76c may comprise a duplex film comprising a single sheet with an adhesive film layer and a surface film layer. In this instance, the duplex first and second surface films 74c and 76c are positioned overlying their corresponding panels 40c and 42c of the inflatable curtain 14c with the adhesive film layers positioned adjacent the panels.

The materials used to construct the woven panels 40c and 42c are selected to provide desired performance characteristics, such as strength, abrasion resistance, puncture resistance, and gas impermeability. For example, the first and second panels 40c and 42c may be constructed of a fabric woven in a 1×1 plain weave pattern using a conventional weaving process, such as rapier, air jet, or water jet weaving. In one example, the yarn used to construct the panels 40c and 42c may be a 470 dtex (470 grams per 10,000 meters) polyamide 66 (PA66) nylon yarn. The construction may have a relatively low weave density, such as 18 picks/cm and 18 ends/cm. In another example, the yarn used to construct the panels 40c and 42c may be a 350 dtex PA66 nylon yarn with a relatively low weave density, such as 23 picks/cm and 23 ends/cm.

The thread used to interconnect the panels 40c and 42c may also be a PA66 nylon thread, such as a T135 (135 grams per 1,000 meters) PA66 nylon thread or a T90 PA66 nylon thread. In one example configuration, a T135 PA66 thread may be used in a double needle lock stitch pattern in which the needle spacing is approximately 3 mm.

Also, as with the embodiment of FIGS. 3-7C and 9-11, the inflatable curtain 14c of FIGS. 13-15B may have a “butterfly” construction in which the first and second panels 40c and 42c are constructed of a single woven panel and the first and second films 74c and 76c are constructed as a single film sheet. The single woven panel would be folded along a fold line to position the first and second panels 40c and 42c adjacent to and overlying each other. The first and second panels 40c and 42c would then be stitched together. Then, the single film sheet-would be wrapped or folded around the stitched together panels 40c and 42c so that the first film 74c overlies the first panel 40c and the second film 76c overlies the second panel 42c. The films 74c and 76c are then laminated to the panels 40c and 42c.

In this instance, the butterfly formed first and second films 74c and 76c would be configured larger than the butterfly formed first and second panels 40c and 42c. As a result, the peripheral overlap portions 340 and 342 are formed when the panels are folded to overlie each other with the first and second panels 40c and 42c sandwiched between.

From the above, those skilled in the art will appreciate that the embodiment of the present invention illustrated in FIGS. 13-15B discloses an inflatable curtain 14c having a design that exhibits desirable gas holding properties. In terms of manufacturing, the inflatable curtain design is both efficient and cost effective. The inflatable curtain 14c utilizes overlying panels 40c and 42c of woven fabric that are uncoated and unlaminated prior to curtain assembly. Once the uncoated, unlaminated overlying panels 40c and 42c are stitched together, film layers 74c and 76c are laminated onto the outer surfaces of the panels so as to cover the panels and the stitching 58c. The film layers 74c and 76c provide an effective seal that helps block or resist gas leakage through the panels 40c and 42c and through the stitching 58c. The peripheral edge seal 344 formed by the laminated peripheral overlap portions 340 and 342, helps bolster or improve this seal.

Advantageously, the first and second film layers 74c and 76c can be applied simultaneously, do not require curing, and require little time to cool, which helps reduce manufacturing time. The fact that the panels 40c and 42c are also free from any coatings further helps to reduce manufacturing time, due to the fact that coatings typically require a significant of time for curing.

From the above, those skilled in the art will appreciate that the embodiment of the present invention illustrated in FIGS. 13-15B relates not only to the construction of the inflatable curtain 14c per se, but also to the method by which the inflatable curtain is manufactured. More particularly, referring to FIG. 16, a method 350 for manufacturing an inflatable vehicle occupant protection device (e.g., an inflatable curtain) includes the step 352 of providing first and second panels of woven material positioned overlying each other. The method 350 also includes the step 354 of stitching together the overlying first and second panels. The method 350 also includes the step 356 of providing first and second film layers larger than the first and second woven panels. The method 350 also includes the step 358 of laminating the first film layer onto the first woven panel and over the stitching. The method 350 also includes the step 360 of laminating the second film layer onto the second woven panel and over the stitching. The method 350 further includes the step 362 of laminating peripheral overlap portions of the first and second film layers to each other to form a peripheral edge seal of the inflatable curtain.

Also, from the above, those skilled in the art will appreciate that the embodiments of the present invention illustrated in FIGS. 3-7, 9-11, and 13-15 relate not only to constructions of an inflatable curtain per se, but also to the method by which the inflatable curtain is manufactured. More particularly, referring to FIG. 17, a method 400 for manufacturing an inflatable vehicle occupant protection device (e.g., an inflatable curtain) includes the step 402 of providing first and second panels of woven material that are uncoated and unlaminated. The method 400 also includes the step 404 of stitching together the overlying first and second panels. The method 400 further includes the step 406 of laminating film layers onto the panels and covering the stitching.

From the above description of the invention, those skilled in the art will perceive improvements, changes and modifications. For example, the cut, sewn, and laminated construction of the present invention could be used to manufacture types of inflatable vehicle occupant protection devices other than an inflatable curtain, such as a frontal air bag, a side air bag, an inflatable knee bolster, or an inflatable seatbelt. Such improvements, changes and modifications within the skill of the art are intended to be covered by the appended claims.

Having described the invention, the following is claimed:

1. An inflatable vehicle occupant protection device comprising:
a woven panel comprising first and second side panels positioned overlying each other;
stitching that extends through and interconnects the overlying first and second side panels, the first and second side panels prior to being stitched together being free from any coating or lamination on any surface; and
a film layer laminated onto the woven panel, the film layer covering the woven panel and the stitching.

2. The inflatable vehicle occupant protection device recited in claim 1, wherein the second side panel is configured to leave exposed portions of the first side panel extending about a periphery of the first side panel, the film layer covering the exposed portions of the first side panel.

3. The inflatable vehicle occupant protection device recited in claim 2, wherein the exposed portions of the first side panel extend about a periphery of the first side panel where the first and second side panels are interconnected by the stitching.

4. The inflatable vehicle occupant protection device recited in claim 2, wherein the film layer forms a peripheral edge seal that helps block inflation fluid from leaking between the overlying first and second side panels.

5. The inflatable vehicle occupant protection device recited in claim 2, wherein the film layer is laminated to an outer surface of the first panel, an outer surface of the second panel, and the exposed portions of the first panel, the exposed portions comprising portions of an inner surface of the first panel.

6. The inflatable vehicle occupant protection device recited in claim 5, wherein the film layer is laminated via heat and pressure.

7. The inflatable vehicle occupant protection device recited in claim 1, further comprising a gasket disposed between the first and second side panels, the gasket comprising a narrow strip of film extending along at least a portion of a periphery of the side panels.

8. The inflatable vehicle occupant protection device recited in claim 7, wherein the gasket is laminated to the first and second side panels.

9. The inflatable vehicle occupant protection device recited in claim 8, wherein the film layer and gasket are laminated simultaneously via heat and pressure.

10. The inflatable vehicle occupant protection device recited in claim 7, wherein the gasket helps block inflation fluid from leaking between the overlying first and second side panels and through portions of the side panels through which the stitching extends.

11. The inflatable vehicle occupant protection device recited in claim 7, wherein the gasket comprises narrow strip segments of gasket material arranged between the first and second side panels along a periphery of the first and second side panels.

12. The inflatable vehicle occupant protection device recited in claim 1, wherein the film layers are configured to have peripheral overlap portions that extend beyond peripheries of the first and second side panels, the peripheral overlap portions overlying each other and being laminated to each other to form a peripheral edge seal that helps block inflation fluid leakage from between the first and second panels.

13. The inflatable vehicle occupant protection device recited in claim 12, further comprising a gasket disposed between the first and second side panels, the gasket comprising a narrow strip of film extending along at least a portion of a periphery of the side panels.

14. The inflatable vehicle occupant protection device recited in claim 13, wherein the film layer and gasket are laminated to the side panels simultaneously via heat and pressure.

15. The inflatable vehicle occupant protection device recited in claim 1, wherein the film layer comprises an adhesive film layer and a surface film layer.

16. The inflatable vehicle occupant protection device recited in claim 1, wherein the adhesive film layer comprises a polyurethane film layer and the surface film layer comprises a copolyester film layer.

17. The inflatable vehicle occupant protection device recited in claim 1, wherein the film layer comprises one of a duplex film comprising an adhesive film and a surface film and a co-ex film comprising an adhesive film and a surface film.

18. The inflatable vehicle occupant protection device recited in claim 7, wherein the gasket comprises a polyurethane adhesive film.

19. The inflatable vehicle occupant protection device recited in claim 1, wherein the woven panel is folded to define the first and second side panels.

20. The inflatable vehicle occupant protection device recited in claim 1, wherein the protection device comprises an inflatable curtain inflatable away from a vehicle roof to a position between a vehicle side structure and a vehicle occupant.

21. An inflatable vehicle occupant protection device comprising:
first and second panels of woven material positioned overlying each other, the second panel being configured to leave exposed portions of the first panel extending about a periphery of the first panel;
stitching that extends through and interconnects the overlying first and second panels;
a first film layer overlying the first panel and covering the stitching; and
a second film layer overlying the second panel and covering the stitching, the second film layer also covering the exposed portions of the first panel.

22. An inflatable vehicle occupant protection device comprising:
first and second panels of woven material positioned overlying each other;
stitching that extends through and interconnects the overlying first and second panels;
a first film layer overlying the first panel and covering the stitching; and
a second film layer overlying the second panel and covering the stitching, the first and second film layers comprising peripheral overlap portions that extend beyond the peripheries of the first and second panels, the peripheral overlap portions overlying each other and being laminated to each other to form a peripheral edge seal that helps block inflation fluid leakage from between the first and second panels.

23. An inflatable vehicle occupant protection device comprising:
first and second overlying panels of woven material;
a gasket disposed between the first and second panels, the gasket comprising a narrow strip of film extending along at least a portion of a periphery of the panels;
stitching that extends through and interconnects the first panel, the second panel, and the gasket;
a first film layer overlying the first panel and the stitching; and
a second film layer overlying the second panel and the stitching.

24. A method for manufacturing an inflatable vehicle occupant protection device, the method comprising the steps of:
providing first and second panels of woven material, the first and second panels being free from any coating or lamination on any surface;
positioning the first and second panels overlying each other;
stitching together the overlying first and second panels;
laminating a first film layer onto the first panel, the first film layer overlying and covering the first panel and the stitching; and
laminating a second film layer onto the second panel, the second film layer overlying and covering the second panel and the stitching.

25. A method for manufacturing an inflatable vehicle occupant protection device, the method comprising the steps of:
providing first and second panels of woven material positioned overlying each other;
configuring the second panel to leave exposed portions of the first panel extending about a periphery of the first panel;
stitching together the overlying first and second panels;
laminating a first film layer onto the first panel, the first film layer also covering the stitching; and
laminating a second film layer onto the second panel and onto the exposed portions of the first panel, the second film layer also covering the stitching.

26. A method for manufacturing an inflatable vehicle occupant protection device, the method comprising the steps of:
providing first and second panels of woven material;
positioning the first and second panels overlying each other;
positioning a gasket between the first and second panels along at least a portion of a periphery of the panels;
stitching together the first panel, second panel, and gasket;
laminating a first film sheet onto the first panel over the stitching; and
laminating a second film sheet onto the second panel over the stitching.

27. The method recited in claim 26, wherein the step of laminating the first and second film sheets comprises the step of simultaneously laminating the gasket to the first and second panels.

28. A method for manufacturing an inflatable vehicle occupant protection device, the method comprising the steps of:
providing first and second panels of woven material positioned overlying each other;
stitching together the overlying first and second panels;
providing first and second film layers that are larger than the first and second panels;
laminating the first film layer onto the first panel and over the stitching;
laminating the second film layer onto the second panel and over the stitching; and
laminating overlying peripheral overlap portions of the first and second film layers that extend beyond the peripheries of the first and second panels to form a peripheral edge seal.
